(19) United States
(12) Patent Application Publication
(10) Pub. No.: US 2018/0098660 A1
(43) Pub. Date: Apr. 12, 2018

(54) Campfire Ring Grill

(71) Applicant: Brian Joseph Springman, Charlotte, NC (US)

(72) Inventor: Brian Joseph Springman, Charlotte, NC (US)

(21) Appl. No.: 15/291,988

(22) Filed: Oct. 12, 2016

(51) Int. Cl. A47J 37/07

(52) U.S. Cl. CPC A47J 37/0772; A47J 2037/0777

(57) ABSTRACT

The invention turns an existing campfire ring into a cooking grill. The invention temporarily mounts notched vertical supports to the campfire ring sides, thus utilizing the campfire ring as the primary support and sides for the grill, resulting in a light and compact design for transport while maintaining a large grilling surface. The charcoal is held in a perforated tray above the ground to improve combustion and the distance of the grill grate over the coals may be adjusted to control the cooking temperature.

### CROSS-REFERENCE TO RELATED APPLICATIONS

This application claims the benefit of U.S. Provisional Application 62/243,110 filed Oct. 18, 2015, which is herein incorporated by reference in its entirety

### FIELD OF THE INVENTION

The present disclosure is in the technical field of portable cooking apparatuses.

### BACKGROUND OF THE INVENTION

Campers in campgrounds wishing to grill their food must either use the campfire rings supplied by the campground or transport their own grill to the campsite. The supplied campfire rings often include an attached grate for grilling. However, using the supplied campfire ring results in low cooking temperatures, difficulty cooking small items, and poor combustion of the charcoal. Transporting a freestanding grill to the campsite is difficult for the camper when space is limited. Prior art and currently sold products are intended for cooking over open campfires in the backcountry and not at established campgrounds. This invention utilizes an existing campfire ring as support making it light and compact for transport while allowing controlled cooking temperatures.

Existing campfire rings may include an attached grate for cooking but these grates are too high above the bed of the charcoal to produce high cooking temperatures. Campfire rings with grates often allow a minimum distance of seven inches between the charcoal and the grate. Ideal cooking temperature for grilling hamburgers is 350 degrees Fahrenheit requiring a distance of 5 inches between the charcoal and grate. Ideal cooking temperature for steaks is 750 degrees Fahrenheit requiring a distance of 3.5 inches between the charcoal and grate.

Supplied campfire rings also have other issues which don't make them ideal for grilling. They often have large spaces between the grate bars. The large spaces make it difficult to grill small items such as vegetable slices without them falling into the fire. In addition, the cooking charcoal must be placed on the ground restricting airflow through the charcoal bed, resulting in lower temperatures and uneven combustion.

Transporting a freestanding grill is often not practical for the camper since space in their vehicle is limited. A full size grill requires disassembling the supporting legs and the body of the grill still takes a large volume of space. A small freestanding transportable grill must shrink the grilling surface and still provide sides and supporting legs. Small freestanding transportable grills often cannot adjust the distance between the charcoal bed and grill surface to control cooking temperature.

Prior art and grilling options currently being sold primarily consist of grates supported by spikes driven into the ground. These are primarily intended for cooking over an open fire in the backcountry and not at established campgrounds. These campfire grills provide a relatively small cooking surface and do not hold the charcoal above the ground to improve combustion.

### BRIEF SUMMARY OF THE INVENTION

The present disclosure describes a portable cooking apparatus which is designed for use on existing campfire rings. An existing campfire ring serves as the primary support and sides for the grill resulting in a light and compact design for transport while maintaining a large grilling surface. The distance of the grill grate over the coals may be adjusted to control the cooking temperature. The charcoal is held in a perforated charcoal tray above the ground to improve combustion.

The portable cooking apparatus comprises: a plurality of notched vertical supports; a grill grate which operationally attaches to said notched vertical supports; a charcoal tray which operationally attaches to said notched vertical supports below said grill grate. All the components store compactly inside said charcoal tray for transport.

The plurality of notched vertical supports comprises four notched vertical supports which hang over the edge of the campfire ring and have screws that can lock the supports onto the campfire ring. The notched vertical supports contain multiple notches to allow adjustment of the distance between the grill grate and charcoal tray.

The grill grate is a semicircle grate with four adjustable tabs.

The charcoal tray is designed to hold charcoal. The charcoal tray is a semicircular tray of larger radius than the grill grate with vent holes and four adjustable tabs.

The adjustable tabs on the grill and charcoal tray rest in the notches of the supports and allow the grill to fit campfire rings of varying diameters as well as to adjust the distance between the charcoal tray and grill. The adjustable tabs consist of wire which slide through hollow guides.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE SEVERAL VIEWS OF THE DRAWING

FIG. 1—A perspective view of the campfire ring grill assembled on a campfire ring:

FIG. 2—A perspective view of the charcoal tray:

FIG. 3—A plan view of the grill grate:

FIG. 4—An enlarged perspective view of one notched support:

FIG. 5—An enlarged perspective view of an adjustable tab used on both the grill and charcoal tray. The adjustable tab consists of a wire hoop which slides through two hollow guides:

FIG. 6—A perspective view of the campfire ring grill packed for storage, with the grill grate and four notched vertical supports placed inside the charcoal tray.

### DETAILED DESCRIPTION OF THE INVENTION

A campfire ring grill consists of three components: a group of four notched vertical supports, a charcoal tray, and a grill grate. The components assemble to create a grill which is supported by and fits within various diameter campfire rings. The components also allow for adjustments of the distance between the charcoal and the cooking surface.

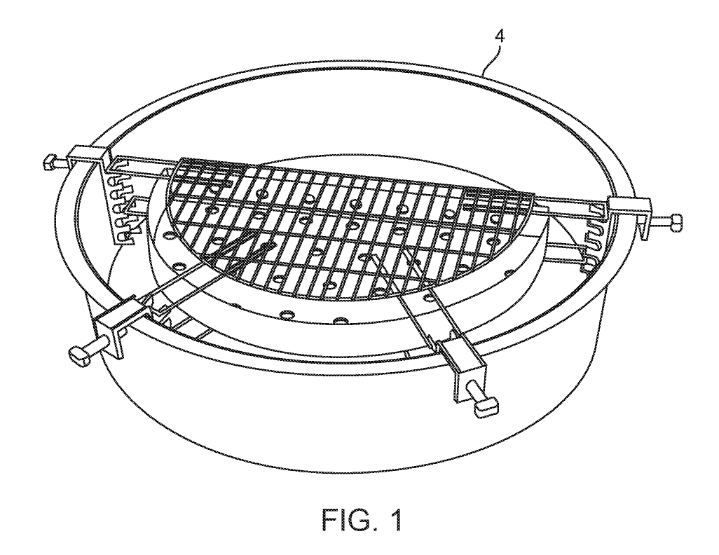

Drawings FIG. 1 through FIG. 6 are depictions of a campfire ring grill. The drawings are described below.

FIG. 1 is a perspective view of the campfire ring grill assembled on a campfire ring. The four notched vertical supports 1 hang over the edge of the existing campfire ring 4 and are locked to the side of the campfire ring 4 by set screws 5. The charcoal tray 3 rests upon the four notched vertical supports 1 using four adjustable tabs 7 to adjust to the diameter of the existing campfire ring 4. The grill grate 2 rests upon the four notched vertical supports 1 above the charcoal tray 3 using four adjustable tabs 6 to adjust to the diameter of the existing campfire ring 4.

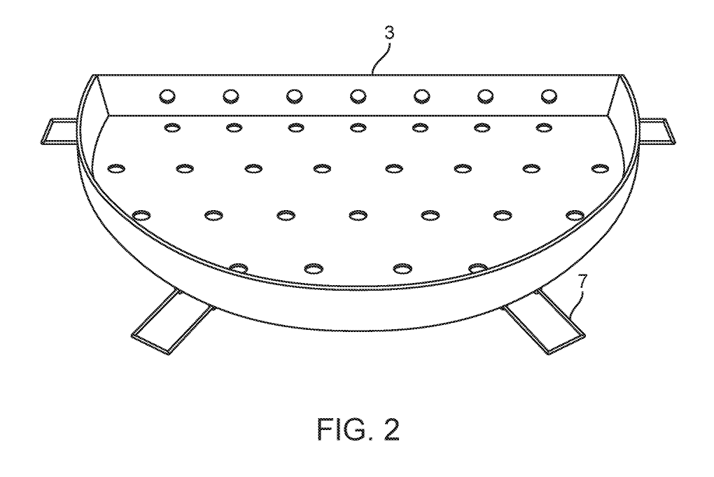

FIG. 2 shows a charcoal tray 3. Said charcoal tray 3 holds the burning charcoal and comprises a metal semi-circular horizontal plate with short vertical sides. Said metal semi-circular horizontal plate and said short vertical sides both have vent holes to allow even combustion. A group of four adjustable wire tabs 7 are placed at 60 degree increments on the bottom of said metal semi-circular horizontal plate. Said group of four adjustable wire tabs 7 are situated along the radius of said metal semi-circular horizontal plate. Said metal semi-circular horizontal plate is made greater than 180 degrees, the short radius between the center point of said metal semi-circular horizontal plate and the flat edge must be equal or greater to half the width of said adjustable wire tabs 7. Extending said metal semi-circular horizontal plate past 180 degrees allows said adjustable tabs 7 adjacent to the flat edge to be attached to said metal semi-circular horizontal plate with their center line along the radius of said metal semi-circular horizontal plate. Said charcoal tray is supported within said campfire ring by extending said group of four adjustable wire tabs 7 to fit within the notches of said group of four notched vertical supports attached to the wall of said campfire ring.

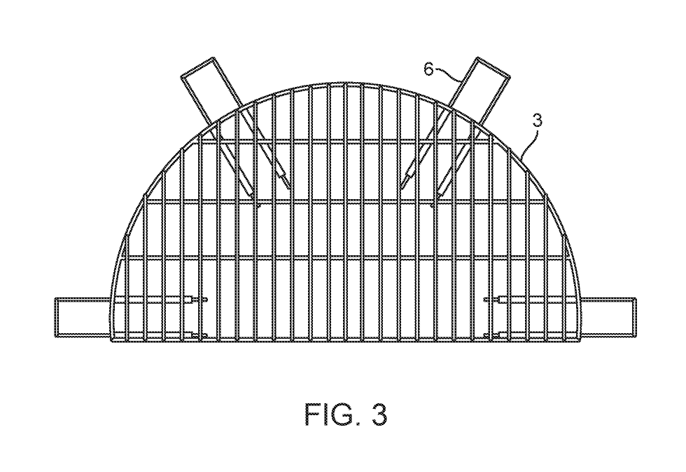

FIG. 3 shows the grill grate 3 is a similar shape as said charcoal tray and comprises a grid of overlapping wires. Thick wires (approximately two gauge) make up the perimeter and widely spaced interior grid. Thinner wires (approximately eight gauge) are placed on top of and perpendicular to the lower supporting grid of wires with a narrow spacing. A second group of four adjustable wire tabs 6 are attached to said grill grate 3 in the same orientation as said charcoal tray. Said grill grate 3 is also a semicircle extending past 180 degrees, but has a slightly shorter radius than said charcoal tray for two reasons: to ensure charcoal heat extends to the edge of said grill grate 3 and so said grill grate 3 can be placed inside said charcoal tray for storage and transport. Said grill grate 3 is supported within said campfire ring in the same manner as said charcoal tray by extending said second group of four adjustable wire tabs 6 to fit within said group of four notched vertical supports attached to the wall of said campfire ring. Said grill grate 3 is placed a group of notches above those used by said charcoal tray, the spacing between said group of notches used determining the relative distance between the charcoal and said grill grate 3 and the resulting cooking temperature.

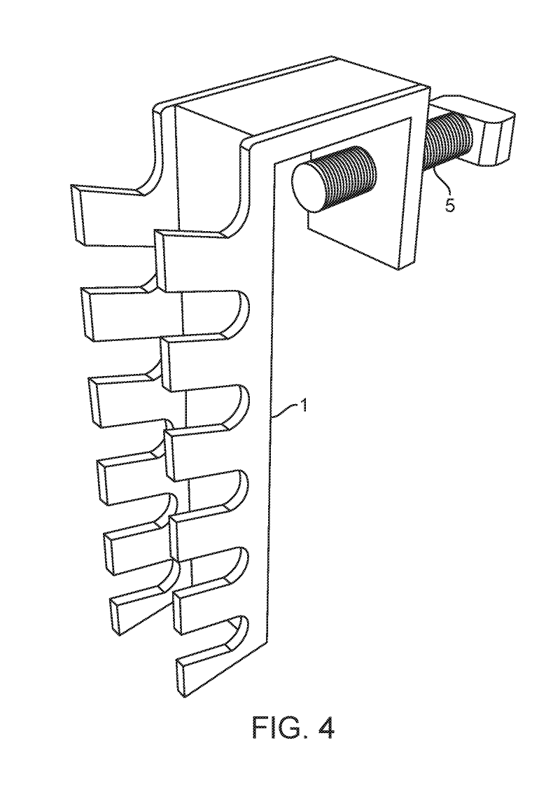

FIG. 4 shows one of the notched vertical supports. Said notched vertical supports 1 hang over the upper lip of the existing campfire ring. Said group of four notched vertical supports 1 may be constructed of stamped and folded sheet metal or cast and machined metal. Said group of four notched vertical supports 1 each consists of two parts; a notched support and a set screw 5 which runs through a tapped hole on the outer diameter of the support. When tightened, said set screw 5 clamps the said campfire ring's vertical wall between the inner vertical portion of said notched vertical support 1 and said set screw 5.

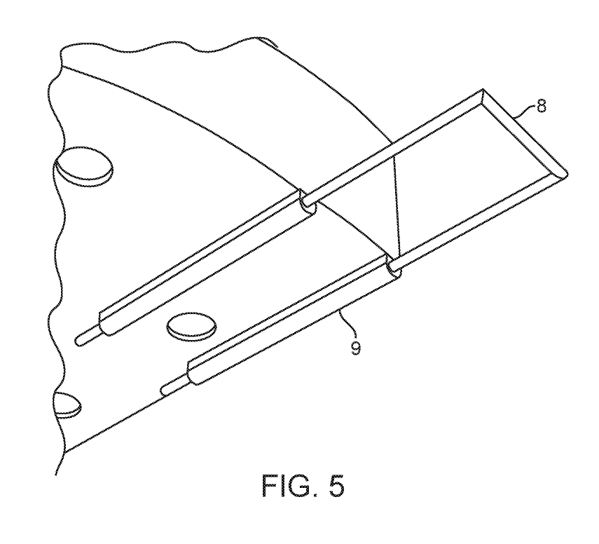

FIG. 5 shows an adjustable wire tab which is a component of said group of four adjustable wire tabs 7 consists of a pair of hollow metal tubes 9 and a bent U-shaped piece of wire 8. The outside edge of said pair of hollow metal tubes 9 is placed on the circumference of said metal semi-circular horizontal plate. The ends of said bent U-shaped piece of wire 8 slide through said pair of hollow metal tubes 9 allowing said bent U-shaped piece of wire 8 to be extended or retracted along the radius of said metal semi-circular horizontal plate to fit the diameter of said campfire ring.

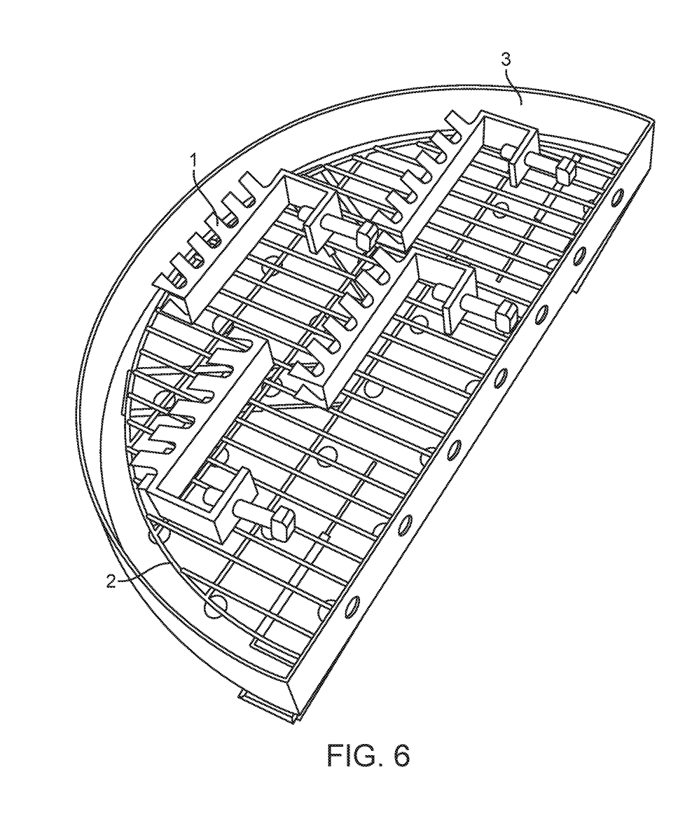

FIG. 6 shows all the components of the campfire ring grill stored with the charcoal tray 3 for transportation. The grill grate 2 is placed in the bottom of the charcoal tray 3. The group of four notched vertical supports 1 are laid on their sides on top of the grill grate 2.

In terms of use, a method for grilling includes:
a) hanging notched vertical supports 1 over the edge of a campfire ring 4;
b) expanding the wire 8 of the adjustable tabs 6 on the charcoal tray 3 to match the diameter of the campfire ring 4 minus the thickness of the vertical supports 1;
c) lowering the charcoal tray 3 into the campfire ring 4;
d) sliding the notched vertical supports 1 along the edge of the campfire ring 4 to align with the adjustable tabs 6 of the charcoal tray 3;
e) resting the wire 8 of the adjustable tabs 6 in the notches of the notched vertical supports 1 based upon the desired distance between the charcoal tray 3 and grill grate 2;
f) screwing the screws 5 on the notched vertical supports 1 to lock the notched vertical supports 1 to the sides of the campfire ring 4;
g) filling the charcoal tray 3 with fuel;
h) expanding the wire 8 of the adjustable tabs 6 on the grill grate 2 to match the diameter of the campfire ring 4 minus the width of the notched vertical supports 1;
i) lowering the grill grate 2 into the campfire ring 4;
j) resting the wire 8 of the adjustable tabs 6 in the notches of the notched vertical supports 1 based upon the desired distance between the charcoal tray 3 and grill grate 2;
k) placing food on the grill grate 2;
l) cooking the food.

In terms of use, a method for storing the grill includes:
a) lift the grill grate 2 off the notched vertical supports 1;
b) sliding the wire 8 of the adjustable tabs 6 flush to the edge of the grill grate 2;
c) cleaning the grill grate 2 and setting aside;
d) lifting the charcoal tray 3 off the notched vertical supports 1;
e) emptying the charcoal tray 3;
f) sliding the wire 8 of the adjustable tabs 6 flush to the edge of the charcoal tray 3;
g) cleaning the charcoal tray 3 and setting aside;
h) unscrewing the set screws 5 on the notched vertical supports 1;
i) lifting the notched vertical supports 1 from the campfire ring;
j) placing the grill grate 2 inside the charcoal tray 3;
k) placing the vertical supports 1 inside the charcoal tray 3.

1. A portable cooking apparatus, the apparatus comprising:
a plurality of notched vertical supports wherein said four notched vertical supports operationally attach to an existing campfire ring for support by hanging over the edge of said campfire ring and locking in place with set screws;
a grill grate which operationally attaches to the said notched vertical supports by resting expandable support tabs in the notches of said notched vertical supports; and
a charcoal tray which operationally attaches to the said four notched vertical supports below the said grill grate by resting expandable support tabs in a notch of said four notched vertical supports.

2. The invention of claim 1, wherein said charcoal tray holds the fuel above the ground.

3. The invention of claim 1, further comprising a plurality of expandable support tabs attached to said charcoal tray and said grill grate which are able to accommodate campfire rings of different diameters.

4. The invention of claim 1, wherein said notched vertical supports allow adjustment of the vertical distance between said charcoal tray and said grill grate.

5. The invention of claim 1, wherein said notched vertical supports and said grill grate fit inside said charcoal tray.

6. The invention of claim 1, wherein said charcoal tray has a radius greater than 180 degrees so said expandable support tabs adjacent to the flat edge can attach to said charcoal tray and expand along the radius of said charcoal tray.

7. The invention of claim 1, wherein said grill grate has a radius greater than 180 degrees so said expandable support tabs adjacent to the flat edge can attach to said grill grate and expand along the radius of said grill grate.
